(19) United States
(12) Patent Application Publication
(10) Pub. No.: US 2019/0009393 A1
(43) Pub. Date: Jan. 10, 2019

(54) SPAN-ADJUSTABLE WRENCH

(71) Applicants: Gyu Chol KIM, Asan-si, Chungcheongnam-do (KR); Ok Rye BAEK, Asan-si, Chungcheongnam-do (KR)

(72) Inventors: Gyu Chol KIM, Asan-si, Chungcheongnam-do (KR); Ok Rye BAEK, Asan-si, Chungcheongnam-do (KR)

(21) Appl. No.: 15/747,824

(22) PCT Filed: Nov. 10, 2016
(86) PCT No.: PCT/KR2016/012946

§ 371 Date: Jan. 26, 2018

(30) Foreign Application Priority Data
Dec. 7, 2015 (KR) 10-2015-0173059

(51) Int. Cl. B25B 13/22; B25B 13/58

(52) U.S. Cl. CPC B25B 13/22; B25B 13/58

(57) ABSTRACT

A span-adjustable wrench including: an elongate handle; a head connected to a distal end of the handle and having a guide slot and a through opening; a fixed jaw coupled to the head; a moveable jaw having a guide rail integral thereto; a span adjustment and keeping insert inserted into the through-opening; and a spring configured to press the span adjustment and keeping insert toward the guide slot.

### CROSS REFERENCE TO PRIOR APPLICATIONS

This application is a National Stage Patent Application of PCT International Patent Application No. PCT/KR2016/012946 (filed on Nov. 10, 2016) under 35 U.S.C. § 371, which claims priority to Korean Patent Application No. 10-2015-0173059 (filed on Dec. 7, 2015), which are all hereby incorporated by reference in their entirety.

### BACKGROUND

The present disclosure relates to a span-adjustable wrench capable of adjusting a span between jaws according to the size of the bolt or nut to be fastened, and more particularly, to a span-adjustable wrench capable of preventing the span from being extended in fastening or unfastening the nut or bolt.

When tightening or releasing bolts or nuts, a spanner or wrench having a span designed to fit the dimensions of the nut or bolt is employed.

The wrench cannot be used when fastening bolts with dimensions other than a specified dimension to the wrench. Thus, using a ‘monkey wrench’ with adjustable span between jaws, the worker can tighten bolts with various dimensions.

The monkey wrench is disclosed in Korean Patent No. 20-0211110 tilted as

“Monkey wrench”. In this document, a rack tooth 4b is formed at a lower end of a movable jaw 4, and a worm gear 6 engaged with the rack tooth is disposed in a head 2. As the worm gear is rotated, the movable jaw 4 moves linearly and a span with a fixed jaw 3 and the movable jaw may be adjusted.

However, the rack teeth of the movable jaw and the teeth of the worm gear contact each other obliquely relative to the direction in which the movable jaw moves. Therefore, when the bolt is strongly tightened, the span is changed by the force that the bolt presses the movable jaw. Thus, the worm gear rotates slightly. Thereby, when another bolt having the same dimension are to be fastened, the span must be corrected.

In addition, there is a problem that the thickness of the head must be made thicker than necessary to fit the outer diameter of the worm gear.

[Prior Art Document] Patent Document 1: KR 20-0211110 Y1

### SUMMARY

The present disclosure has been made to solve the above problems of the prior art. The present disclosure is to provide a span-adjustable wrench that can prevent the span from increasing even when tightening bolts or nuts tightly, thereby to eliminate the need to correct the span between the jaws.

In one aspect of the present disclosure, there is provided a span-adjustable wrench comprising: an elongate handle having opposite proximal and distal ends; a head formed of a flat type structure connected to the distal end of the handle, wherein the head has an elongate guide slot defined in a longitudinal distal end portion of the head, and wherein the head has a through-opening defined therein communicating with the guide slot; a fixed jaw pivotally pin-coupled to the head so as to pivot only in one direction; a moveable jaw having a guide rail integral thereto, wherein the guide rail is slidably inserted into the guide slot, wherein a span is defined between the movable jaw and the fixed jaw; a span adjustment and keeping insert inserted into the through-opening; a spring configured to press the span adjustment and keeping insert toward the guide slot; and a pressing mechanism configured to selectively press the fixed jaw, wherein the moveable jaw has first teeth formed along a longitudinal end face of the guide rail, wherein the span adjustment and keeping insert has second teeth integral thereto, the second teeth being formed on a first end face thereof facing the longitudinal end face of the guide rail, wherein the second teeth are selectively partially engaged with the first teeth to define the span.

In one implementation, outer edges of the first teeth of the moveable jaw and outer edges of the second teeth of the span adjustment and keeping insert are chamfered.

In one implementation, the span-adjustable wrench further comprises a first fixing-pin receiving hole defined in the head, wherein the first receiving hole extends in parallel with the guide slot and communicates with the through-opening; a second fixing-pin receiving hole defined in the span adjustment and keeping insert, wherein second fixing-pin receiving hole extends in parallel with the guide slot; and a fixing-pin inserted into the second fixing-pin receiving hole and the first fixing-pin receiving holes, wherein the fixing-pin has a diameter substantially equal to a width of the first fixing-pin receiving hole.

In one implementation, the span-adjustable wrench further comprises a first fixing-pin receiving hole defined in the head, wherein the first receiving hole extends in parallel with the guide slot and communicates with the through-opening; a second fixing-pin receiving hole defined in the span adjustment and keeping insert, wherein second fixing-pin receiving hole extends in parallel with the guide slot; and a fixing-pin inserted into the second fixing-pin receiving hole and the first fixing-pin receiving holes, wherein the fixing-pin has a diameter substantially equal to a width of the second fixing-pin receiving hole. In one implementation, the span-adjustable wrench further comprises a fixing-pin adjuster attachment coupled to the fixing-pin and attached to an outer face of the head.

In one implementation, the span-adjustable wrench further comprises friction protrusions on both exposed outer faces of the span adjustment and keeping insert.

In one implementation, the span-adjustable wrench further comprises a stopper protruding from one lateral end of the longitudinal end face of the guide rail, wherein the stopper has a protrusion dimension larger than that of each of the first teeth.

In one implementation, the span-adjustable wrench further comprises a stopper protruding from one lateral side of the distal end portion of the head.

In one implementation, the span-adjustable wrench further comprises an elongate groove or protrusion defined on the guide slot, wherein the elongate groove or protrusion extends in a corresponding manner to the guide rail.

In one implementation, the span-adjustable wrench further comprises a plurality of friction protrusions formed on an inner surface of the movable jaw and an inner surface of the fixed jaw, respectively, wherein the inner surface of the movable jaw faces the inner surface of the fixed jaw.

In one implementation, the head is pivotally pin-coupled to the distal end of the handle so as to pivot only in one direction, wherein the pressing mechanism includes: an elongate pressing member having: a proximal end pivotally pin-coupled to a pin joint point between the handle and the head; a middle portion pivotally pin-coupled to a pin joint point between the head and the fixed jaw, and a distal free end abutting against the fixed jaw; and a further spring configured to exert a force to allow a spacing between the head and the distal end of the handle.

In one implementation, the span-adjustable wrench further comprises a release lever coupled to the proximal end of the head.

Using the span-adjustable wrench according to the present disclosure, the increase of the span between the moving jaw and the fixed jaw may be suppressed when tightening bolts or nuts with various dimensions, so that there is no need to correct the span.

When the fixed jaw of the span-adjustable wrench is pin-coupled to the head and the span-adjustable wrench further comprises the pressing mechanism, the successive and sequential fastening operations of the bolt or nut may be completed without removing the wrench from the bolt or nut.

### BRIEF DESCRIPTION OF THE DRAWINGS

FIG. 1 is an assembled perspective view of a span-adjustable wrench according to a first embodiment of the present disclosure.

FIG. 2 is an exploded perspective view of the span-adjustable wrench according to the first embodiment of the present disclosure.

FIG. 3 is an explanatory view of first teeth and second teeth of the span-adjustable wrench according to the first embodiment of the present disclosure.

FIG. 4 is an assembled perspective view of a span-adjustable wrench according to a second embodiment of the present disclosure.

FIG. 5 is an exploded perspective view of the span-adjustable wrench according to a second embodiment of the present disclosure.

FIGS. 6 and 7 are explanatory views of a pressing mechanism of the span-adjustable wrench according to the second embodiment.

### DETAILED DESCRIPTION

Hereinafter, specific embodiments of the present disclosure will be described in detail with reference to the drawings.

The present disclosure provides a wrench that can be used to fasten bolts or nuts of various sizes, by enabling the span to be adjusted between the jaws to meet the dimension of the bolts or nuts to be fastened or unfastened. Further, when the bolt or the nut is tightly fastened or unfastened, the span does not increase and, thus, it is not necessary to correct the span.

Hereinafter, as used herein, the expression ‘fastening’ a bolt or nut with a wrench includes not only the fastening but also an unfastening of the bolt or the nut.

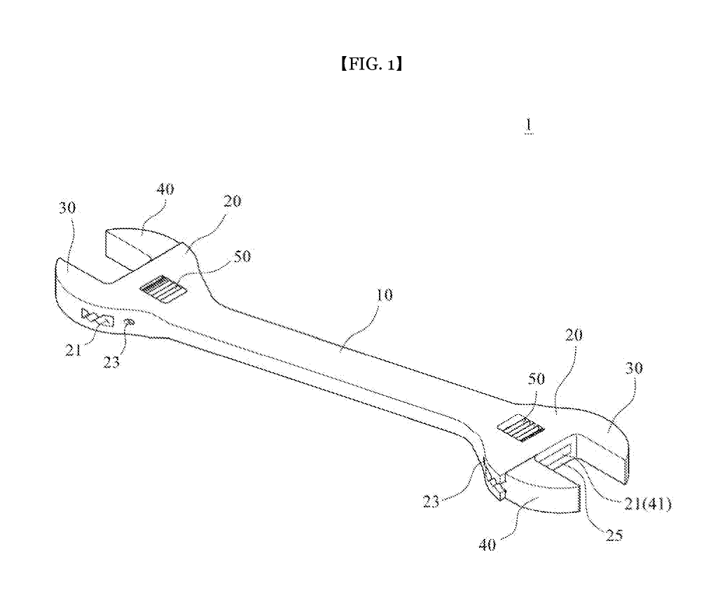

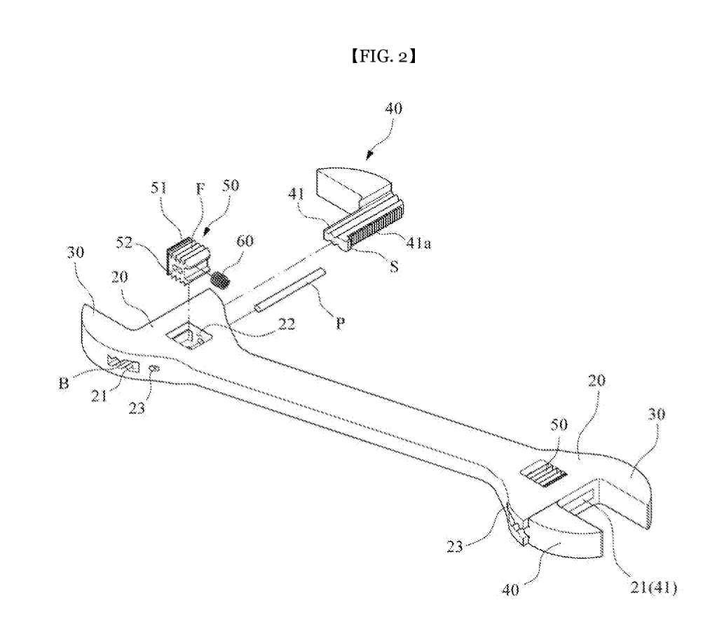

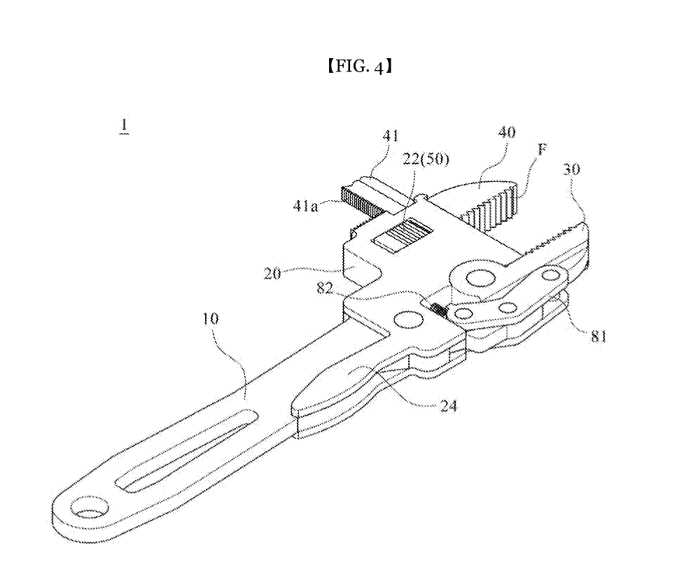

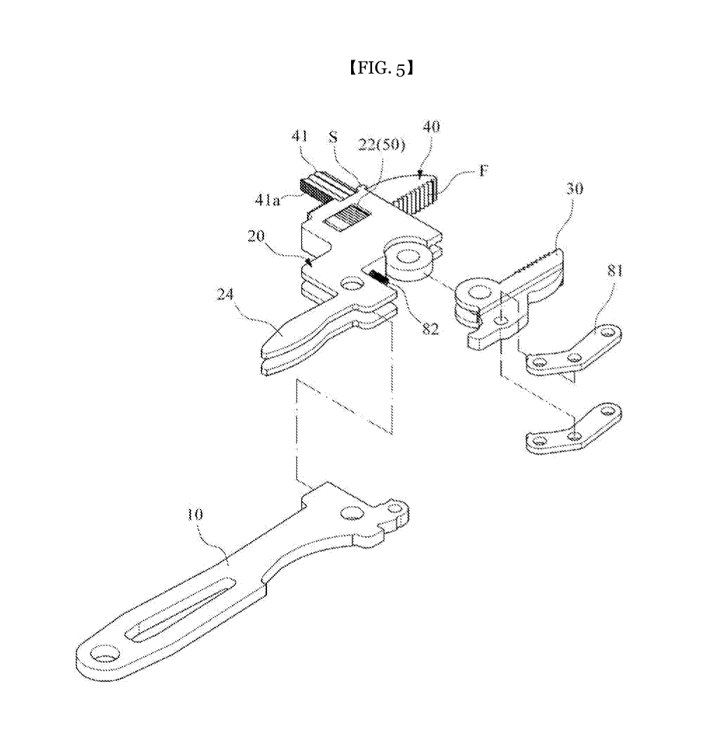

FIG. 1 is an assembled perspective view of a span-adjustable wrench 1 according to a first embodiment of the present disclosure. FIG. 2 is an exploded perspective view of the span-adjustable wrench 1 according to the first embodiment of the present disclosure. FIG. 4 is an assembled perspective view of a span-adjustable wrench 1 according to a second embodiment of the present disclosure. FIG. 5 is an exploded perspective view of the span-adjustable wrench 1 according to a second embodiment of the present disclosure. First, the first embodiment will be described in details.

The span-adjustable wrench 1 according to the first embodiment of the present disclosure includes a handle 10, a head 20, a fixed jaw 30, a moveable jaw 40, a span adjustment and keeping insert 50 and a spring 60.

The handle 10 is formed in a long rod shape as a part to be held by a hand of an operator when fastening a bolt or nut using the wrench.

The head 20 is a flat type structure connected to a distal end of the handle 10. The fixed jaw 30 is projected distally from one side of a face 25 of a distal end of the head 20. The moveable jaw 40 protrudes distally from the other side of the face 25 of the distal end of the head. The moveable jaw 40 moves along the face 25 of the distal end of the head 20, as can be seen by its name, to allow adjustment of the span with the fixed jaw 30 and the moveable jaw 40.

Within the face portion 25 of the distal end of the head 20, a guide slot 21 is formed along a longitudinal direction of the span in the middle of the thickness of the head, so that the moveable jaw 40 can move along the head 20. A guide rail 41 is integrally formed to the moveable jaw 40. The guide rail 41 has a shape engaging with the guide slot 21. With the guide rail 41 of the moveable jaw 40 being inserted into the guide slot 21, the guide rail 41 moves along the longitudinal direction of the guide slot 21.

Below the face portion 25 of the head 20, that is, at the central region of the head, a through-opening 22 communicating with the guide slot 21 is formed. The span adjustment and keeping insert 50 is inserted into the through-opening 22.

The span adjustment and keeping insert 50 serves to fix the moveable jaw 40 at a fixed position. When fastening a bolt or nut, the span adjustment and keeping insert 50 allows the span between the fixed jaw 30 and the moveable jaw 40 to remain constant.

More specifically, first teeth 41a are formed on the face of a longitudinal end of the guide rail 41 of the moveable jaw 40. Second teeth 51 are formed, in the longitudinal direction of the span, on a first end face of the span adjustment and keeping insert 50 facing the longitudinal end of the guide rail 41 of the moveable jaw. By engaging the first and second teeth 41a, 51, the moveable jaw 40 is fixed.

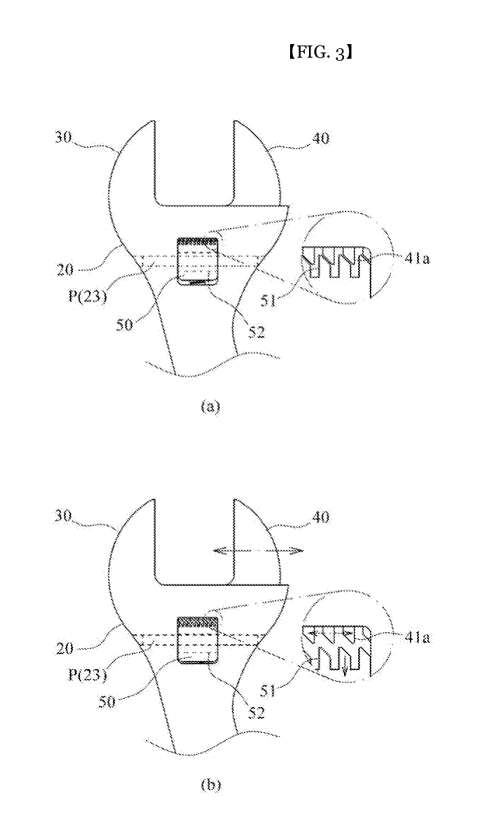

FIG. 3A shows that the first teeth 41a of the moveable jaw 40 and the second teeth 51 of the span adjustment and keeping insert 50 are engaged with each other. The spring 60 is located between a proximal inner side face of the through-opening 22 of the head 20 and a proximal outer end face, that is, opposite to the first end face of the span adjustment and keeping insert 50. The spring 60 is configured to urge the span adjustment and keeping insert 50 toward the guide slot 21. Therefore, the second teeth 51 of the span adjustment and keeping insert 50 are firmly engaged with the first teeth 41a of the moveable jaw 40.

In order to adjust the span between the moveable jaw 40 and the fixed jaw 30, a force greater than the elastic force of the spring 60 is applied to the span adjustment and keeping insert 50, as shown in FIG. 3b. Thus, the second teeth 51 of the span adjustment and keeping insert 50 are separated from the first teeth 41a of the moveable jaw 40. Thus, the moveable jaw 40 can be moved.

The span adjustment and keeping insert 50 of the span-adjustable wrench 1 according to the present disclosure has a following advantage. Unlike the screw-type span-adjusting mechanism of a conventional monkey wrench (for example, a worm gear disclosed in Korean Patent No. 20-0211110), when the bolts or nuts are fastened, even though the moveable jaw 40 receives a strong force from the bolt or nut, the jaw 40 does not move. Therefore, during bolt or nut tightening, the span between the fixed jaw 30 and the moveable jaw 40 does not change. Thus, in the case of successive fastening of multiple bolts or nuts with the same dimension, there is no need to recalibrate the span between the fixed jaw 30 and the moveable jaw 40.

In one embodiment, outer edges of protrusions of the first teeth 41a of the moveable jaw 40 and outer edges of protrusions of the second teeth 51 of the span adjustment and keeping insert 50 may be chamfered.

In this connection, the chamfered surface of each of the first teeth 41a is tilted toward the fixed jaw 30, while the chamfered surface of each of the second teeth 51 is tilted in an opposite direction to the tilted direction of the chamfered surface of each of the first teeth 41a. The chamfered surface of each of the second teeth 51 is complementary with the chamfered surface of each of the first teeth 41a. Thus, when reducing the span between the moveable jaw 40 and the fixed jaw 30, only pressing the moveable jaw 40 toward the fixed jaw 30 without exerting greater force than the elastic force of the spring 60 to the span adjustment and keeping insert 50 allows the moveable jaw 40 to be moved while the chamfering surfaces of the first teeth 41a slides on and over the chamfered surfaces of the second teeth 51. On the other hand, during the fastening operation of the bolt or nut, the chamfered surfaces of the first and second teeth 41a and 51 are complementarily engaged with each other, thereby preventing the moveable jaw 40 from moving.

The span-adjustable wrench 1 according to the present disclosure may have a fixing pin P that prevents the span adjustment and keeping insert 50 from separating from the through-opening 22 of the head 20.

In this connection, first fixing pin receiving holes 23 are formed in the head 20. The two holes 23 extend in parallel with the guide slot 21 and communicate with intermediate portions of both sides of the through-opening 22 respectively. In the span adjustment and keeping insert 50, a second fixing pin receiving hole 52 extending in parallel with the guide slot 21 is formed. The fixing pin P is inserted into the second fixing pin receiving hole 52 and the first fixing pin receiving holes 23 of the span adjustment and keeping insert 50. In this way, the span adjustment and keeping insert 50 is prevented from detaching from the through-opening 22 of the head 20.

The second fixing pin receiving hole 52 of the span adjustment and keeping insert 50 has a width larger than the diameter of the fixing pin P. As a result, the movement of the span adjustment and keeping insert toward or away from the guide slot 21 50 is not disturbed. In addition, the width of each of the first fixing pin receiving holes 23 is substantially equal to the diameter of the fixing pin so that the fixing pin P is firmly fixed into the first fixing pin receiving holes 23 of the head 20.

In an alternative, the second fixing pin receiving hole 52 of the span adjustment and keeping insert 50 has a width substantially equal to the diameter of the fixing pin. The width of each of the first fixing pin receiving holes 23 is lager than the diameter of the fixing pin.

In this case, the fixing pin P may be movable within each of the first fixing pin receiving holes 23. Thus, the movement of the span adjustment and keeping insert toward or away from the guide slot 21 50 is not disturbed.

In this connection, a fixing-pin adjuster attachment 70 connected to the fixing pin P may be attached to one side of the head 20.

The fixing-pin adjuster attachment 70 is connected to the span adjustment and keeping insert 50 via the fixing pin P. Thus, by moving the fixing-pin adjuster attachment 70, the span adjustment and keeping insert 50 may move in the direction of getting closer to or away from the guide slot 21.

On both exposed side faces of the span adjustment and keeping insert 50, friction protrusions F may be formed.

The friction protrusions F serve as follows. To move the span adjustment and keeping insert 50, the worker may apply upward or downward force to the span adjustment and keeping insert 50 while pressing down the span adjustment and keeping insert 50 with a finger. At this time, due to the friction protrusions F, the finger is not slipped on the span adjustment and keeping insert 50. As a result, the force can be reliably transmitted to the span adjustment and keeping insert 50.

A stopper S may protrude from one lateral end of the longitudinal end face of the guide rail 41 to a projection degree larger than that of the first teeth 41a.

The stopper S plays a role as follows. When applying a force to the span adjustment and keeping insert 50, the moveable jaw 40 is prevented from being completely deviated from the head 20 due to the stopper stopping the second teeth 51 of the span adjustment and keeping insert 50, even though the first teeth 41a and the second teeth 51 are not engaged with each other.

In another embodiment, a second stopper S may protrude from the distal end surface 25 of the head at one end in the span longitudinal direction thereof.

In this regard, the second stopper S limits the movement of the moveable jaw 40 to prevent the moveable jaw 40 from disengaging from the head.

In both sides of the guide slot 21, a long groove or protrusion B may be formed in the longitudinal direction thereof.

The groove or protrusion B is elongated in the longitudinal direction of the slot, whereby the moveable jaw 40 may smoothly move in the longitudinal direction of the guide slot 21. On the other hand, this groove or protrusion B ensures that the moveable jaw 40 does not move in the direction of pressing the span adjustment and keeping insert 50.

In this regard, it is natural that the guide rail 41 of the moveable jaw 40 should have a long protrusion or groove shape-corresponding to the long groove or teeth B of the guide slot 21.

A plurality of friction protrusions F may be formed on the inner surface of the movable jaw 40 and the inner surface of the fixed jaw 30, respectively.

These friction protrusions F serve as a following. When tightening the round bolt, the wrench may slip out of it. With these frictional protrusions F, it is possible to prevent the wrench from slipping and out of the bolt during the bolt fastening operation.

A configuration of the other end of the handle 10 may be the same as that of one end of the handle. That is, at the other end of the handle, the head 20, the fixed jaw 30, the moveable jaw 40, the span adjustment and keeping insert 50, and the spring 60 as described above may be disposed. However, the distance between the first teeth 41a and the distance between the second teeth 51 at the other end of the handle 10 may be different from the distance between the first teeth 41a and the interval between the second teeth 51 at one end of the handle 10 respectively.

The unit of length is often meter and inch. Thus, the distance between the first teeth ₄₁a and the distance between the second teeth 51 may vary depending on which of these units applied to the bolt or nut.

In this connection, the above configuration that the distance between the first teeth 41a and the distance between the second teeth 51 at the other end of the handle 10 may be different from the distance between the first teeth 41a and the interval between the second teeth 51 at one end of the handle 10 respectively may have a following advantage. The moveable jaw 40 and the fixed jaw 30 associated with one end of the handle 10 may be used to fasten bolts or nuts with metric units. On the other hand, the moveable jaw 40 and the fixed jaw 30 associated with the other end of the handle 10 may be used to fasten bolts or nuts with inch units. Thus, the span-adjustable wrench according to the present disclosure may be used to fasten bolts or nuts to which various length units are applied.

In one example, the distance between the first teeth 41a and the distance between the second teeth 51 at the other end of the handle 10 may be set to 1 mm, while the distance between the first teeth 41a and the interval between the second teeth 51 at one end of the handle 10 may be set to 1/32 inch.

Hereinafter, the span-adjustable wrench according to the second embodiment of the present disclosure will be described.

The span-adjustable wrench 1 according to the second embodiment has a following feature. In order for the operator to fasten the bolt or nut, it may be necessary to rotate the wrench multiple times. To do this, the operator uses the wrench to rotate the bolt or nut by a certain angle. Then, he separates the wrench from the bolt or nut. Then, he inserts the bolt nut again into the wrench. Again, he uses the wrench to rotate the bolt or nut by a further certain angle. Then, he separates the wrench from the bolt or nut. Then, he inserts the bolt nut again into the wrench, and so on. Such repetitive work is inconvenient. The span-adjustable wrench 1 according to this second embodiment eliminates this discomfort. The span-adjustable wrench 1 according to this second embodiment may include some and all of the features of the span-adjustable wrench of the first embodiment. Hereinafter, only unique features of the span-adjustable wrench of the second embodiment will be described.

The span-adjustable wrench of the second embodiment, like the span-adjustable wrench of the first embodiment, includes the handle 10, the head 20, the moveable jaw 40, the span adjustment and keeping insert 50 and the spring 60. In this second embodiment, the fixed jaw 30 is pivotally coupled, via the pin, to the head 20, while pivoting in only one direction with respect to the head 20. Further, the wrench according to the present embodiment further includes a pressing mechanism that does not press or press the fixed jaw 30.

The pressing mechanism may be configured such that when the operator presses the handle 10 in one direction to tighten the bolt or nut with the wrench, the pressing mechanism allows the fixed jaw 30 not to pivot relative to the head 20. This allows the moveable jaw 40 and the fixed jaw 30 together to grip the bolt or nut tightly. Conversely, when the handle 10 is pressed in the other direction, the pressing mechanism will allow the fixed jaw 30 to pivot relative to the head 20, thereby to rotate the wrench relative to the bolt or nut without removing the wrench from the bolt or nut.

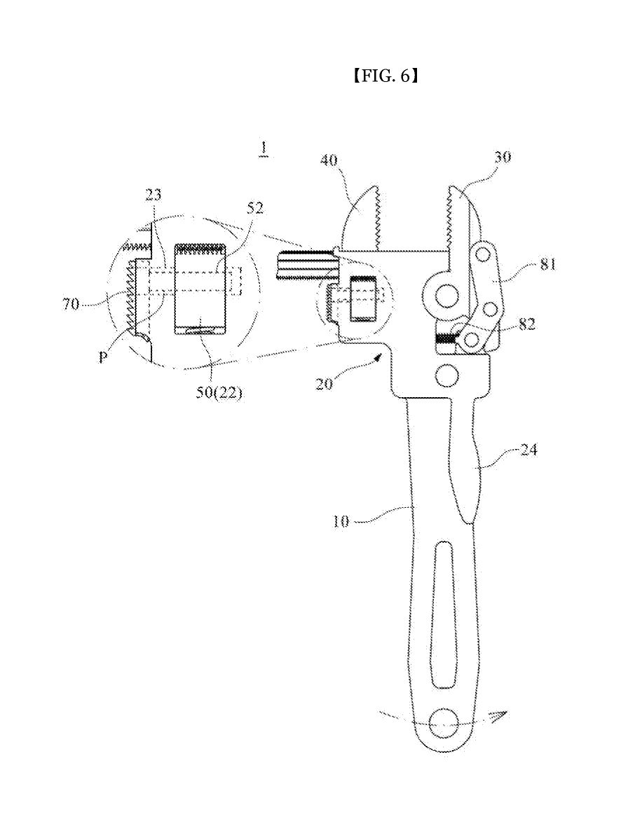

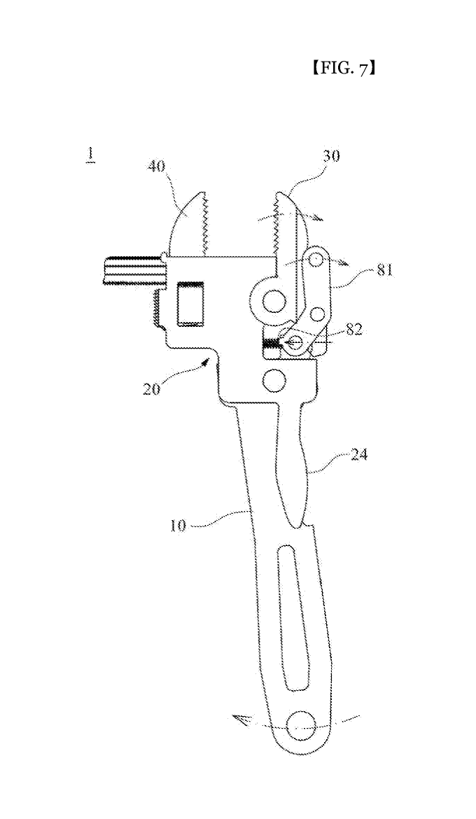

More specifically, the pressing mechanism includes the head 20, a pressing member 81 and a second spring 82. The head 20 is pivotally coupled, via a pin, to one end of the handle 10 so as to pivot in one direction. FIG. 6 and FIG. 7 illustrate the pressing mechanism.

One end of the pressing member 81 is pivotally pin-coupled to the pin joint point between the handle 10 and the head 20. A middle portion of the pressing member 81 is pivotally pin-coupled to the pin joint point between the head 20 and the fixed jaw 30. The other end of the pressing member 81 is a free end and abuts against the fixed jaw 30. The second spring 82 is configured to exert a force to allow a spacing between the head 20 and the distal end of the handle 10.

The head 20 is coupled to the handle 10 to pivot only in one direction with respect to the handle 10. Thus, when the handle 20 of the wrench is not subjected to a force or when a force in one direction is applied to the handle 10 to fasten the bolt or nut, the handle 10 does not pivot and the free end of the pressing member 81 abuts the fixed jaw 30 to maintain the state of pressing the fixed jaw 30. This is shown in FIG. 6.

When the handle 10 is pressured in the other direction, the handle 10 pivots and, thus, a proximal end of the pressing member 81 pivots together with the handle 10, as shown in FIG. 7. In this regard, since the middle portion of the pressing member 81 is pivotally pin-coupled to the fixed jaw 30, the free end or distal end of the pressing member 81 pivots away from the fixed jaw 30. The span between the fixed jaw 30 and the moveable jaw 40 can thus be easily increased with the fixed jaw 30 pivoting relative to the head 20. Thereby, the wrench may pivot around the bolt or nut without removing the wrench from the bolt or nut.

When the force in the other direction is removed from the handle 10, the free end of the pressing member 81 returns to the state of pressing the fixed jaw 30 due to the elastic force of the second spring 82. Since as noted above, the handle 10 is pivotable in only one direction relative to the head 20, the handle 10 may not pivot even when the second spring 82 pivotally pushes one end of the handle 10 relative to the head 20.

FIG. 7 shows the fixing-pin adjuster attachment 70 attached to the wrench according to the present disclosure.

When the span-adjustable wrench has the pressing mechanism as in FIGS. 6 and 7, a release lever 24 may be disposed to one end of the head 20 toward the handle 10.

Pressing the release lever 24 has the same effect as applying force to the handle 10 in the other direction. As a result, the pressing member 81 does not press the fixed jaw 30.

While the disclosure has been shown and described with reference to certain preferred embodiments thereof, it will be understood by those skilled in the art that various changes in form and details may be made therein without departing from the spirit and scope of the disclosure as defined by the appended claims. And thus fall within the scope of the present disclosure.

1. A span-adjustable wrench comprising:
an elongate handle having opposite proximal and distal ends;
a head formed of a flat type structure connected to the distal end of the handle, wherein the head has an elongate guide slot defined in a longitudinal distal end portion of the head, and wherein the head has a through-opening defined therein communicating with the guide slot;
a fixed jaw pivotally pin-coupled to the head so as to pivot only in one direction;
a moveable jaw having a guide rail integral thereto, wherein the guide rail is slidably inserted into the guide slot, and wherein a span is defined between the movable jaw and the fixed jaw;
a span adjustment and keeping insert inserted into the through-opening;
a spring configured to press the span adjustment and keeping insert toward the guide slot; and
a pressing mechanism configured to selectively press the fixed jaw,
wherein the moveable jaw has first teeth formed along a longitudinal end face of the guide rail,
wherein the span adjustment and keeping insert has second teeth integral thereto, the second teeth being formed on a first end face thereof facing the longitudinal end face of the guide rail, and
wherein the second teeth are selectively partially engaged with the first teeth to define the span.

2. The span-adjustable wrench of claim 1, wherein outer edges of the first teeth of the moveable jaw and outer edges of the second teeth of the span adjustment and keeping insert are chamfered.

3. The span-adjustable wrench of claim 1, further comprising:
a first fixing-pin receiving hole defined in the head, wherein the first receiving hole extends in parallel with the guide slot and communicates with the through-opening;
a second fixing-pin receiving hole defined in the span adjustment and keeping insert, wherein second fixing-pin receiving hole extends in parallel with the guide slot; and
a fixing-pin inserted into the second fixing-pin receiving hole and the first fixing-pin receiving holes, wherein the fixing-pin has a diameter substantially equal to a width of the first fixing-pin receiving hole.

4. The span-adjustable wrench of claim 1, further comprising:
a first fixing-pin receiving hole defined in the head, wherein the first receiving hole extends in parallel with the guide slot and communicates with the through-opening;
a second fixing-pin receiving hole defined in the span adjustment and keeping insert, wherein second fixing-pin receiving hole extends in parallel with the guide slot; and
a fixing-pin inserted into the second fixing-pin receiving hole and the first fixing-pin receiving holes, wherein the fixing-pin has a diameter substantially equal to a width of the second fixing-pin receiving hole.

5. The span-adjustable wrench of claim 4, further comprising: a fixing-pin adjuster attachment coupled to the fixing-pin and attached to an outer face of the head.

6. The span-adjustable wrench of claim 1, further comprising: friction protrusions on both exposed outer faces of the span adjustment and keeping insert.

7. The span-adjustable wrench of claim 1, further comprising: a stopper protruding from one lateral end of the longitudinal end face of the guide rail, wherein the stopper has a protrusion dimension larger than that of each of the first teeth.

8. The span-adjustable wrench of claim 1, further comprising: a stopper protruding from one lateral side of the distal end portion of the head.

9. The span-adjustable wrench of claim 1, further comprising: an elongate groove or protrusion defined on the guide slot, wherein the elongate groove or protrusion extends in a corresponding manner to the guide rail.

10. The span-adjustable wrench of claim 1, further comprising a plurality of friction protrusions formed on an inner surface of the movable jaw and an inner surface of the fixed jaw, respectively, wherein the inner surface of the movable jaw faces the inner surface of the fixed jaw.

11. The span-adjustable wrench of claim 1, wherein the head is pivotally pin-coupled to the distal end of the handle so as to pivot only in one direction, and
wherein the pressing mechanism includes:
an elongate pressing member having: a proximal end pivotally pin-coupled to a pin joint point between the handle and the head; a middle portion pivotally pin-coupled to a pin joint point between the head and the fixed jaw; and a distal free end abutting against the fixed jaw; and
a further spring configured to exert a force to allow a spacing between the head and the distal end of the handle.

12. The span-adjustable wrench of claim 1, further comprising a release lever coupled to the proximal end of the head.
